(19) United States
(12) Patent Application Publication
(10) Pub. No.: US 2023/0406635 A1
(43) Pub. Date: Dec. 21, 2023

(54) CONTAINER STORAGE AND RETRIEVAL SYSTEM

(71) Applicant: Ocado Innovation Limited, Hatfield, Hertfordshire (GB)

(72) Inventors: Lars Sverker Ture LINDBO, Hatfield, Hertfordshire (GB); Wilhelm Karl JOHANNISSON, HATFIELD, Hertfordshire (GB); Måns Fredrik Jonathan NILSSON, Hatfield, Hertfordshire (GB)

(73) Assignee: Ocado Innovation Limited, Hatfield, Hertfordshire (GB)

(21) Appl. No.: 18/247,295

(22) PCT Filed: Sep. 29, 2021
(86) PCT No.: PCT/EP2021/076832

§ 371 Date: Mar. 30, 2023

(30) Foreign Application Priority Data
Oct. 1, 2020 (GB) 2015589.1
Dec. 23, 2020 (GB) 2020477.2

(51) Int. Cl. B65G 1/137; B65G 1/04

(52) U.S. Cl. CPC B65G 1/1375; B65G 1/0478

(57) ABSTRACT

This disclosure relates a container storage and retrieval system including a frame structure configured to store a plurality of rows of containers. The system includes a load handling device including a first actuating assembly configured to move a container row lengthwise in order to retrieve a container from the container row for delivery to the workstation or add a container from the workstation to the container row.

This disclosure relates to a container storage and retrieval system. More specifically, it relates to a particular configuration of a container storage and retrieval system that makes better use of available space when compared to known systems, increasing its storage volume. Aspects of the invention relate to the container storage and retrieval system itself, a load handling device for retrieving containers from and storing containers in the container storage and retrieval system, and a method therefor.

### BACKGROUND

Some commercial and industrial activities require storage and retrieval systems that enable the storage and retrieval of a large number of different products. Examples of such systems are shown in WO 2015/019055, WO 2013/167907 and WO 2014/195901. These systems enable large numbers of different products to be stored in and retrieved from a relatively small volume due to their general configurations, which include a plurality of rails or tracks arranged in a grid pattern above stacks of containers. The grid pattern comprises a plurality of grid spaces and each stack is located within a footprint of each grid space. A load handling devices is configured to move laterally on the rails above the stacks, and includes a container-receiving space and a lifting device arranged to lift a container, through a grid space, from a stack into the container-receiving space. The load handling device then moves to another grid space to lower the container for delivery to a workstation. The cost of building warehouses for housing such systems is likely to be increasingly prohibitive and the regulatory requirements more rigorous, particularly in urban areas where space can be limited. As such, there is a perceived need for an alternative system that can make better use of space within warehouses.

### SUMMARY

The invention accordingly provides, in a first aspect, a load handling device for a container storage and retrieval system, the container storage and retrieval system comprising a frame structure configured to store a plurality of rows of containers, the load handling device being positionable between the frame structure and a workstation and comprising a first actuating assembly configured to move a container row lengthwise in order to retrieve a container from the container row for delivery to the workstation or add a container from the workstation to the container row. The fact that the load handling device is configured to pull and push rows of containers from the side means space on top of the containers is not needed for the load handling devices, allowing the accommodation of more rows of containers. The fact that the load handing device is configured to displace a container row lengthwise in order to retrieve or deliver a container to the container row means that it can be positioned at a side of the frame structure as opposed to being positioned on top of the structure, as is the case in known systems. This arrangement eliminates the need to create space on top of the frame structure to accommodate load handling devices.

Optionally, the first actuating assembly is configured to move laterally in a first direction in order to engage a container within a container row adjacent to a first end of the load handling device and in a second opposite direction in order to engage a container from the workstation adjacent to a second opposite end of the load handling device.

Optionally, the first actuating assembly comprises first and second actuating members, wherein the first actuating member is configured to move laterally in the first and second directions so as to move away from and towards the second actuating member respectively.

Optionally, the second actuating member is configured to move laterally in the first and second directions so as to move towards and away from the first actuating member respectively.

Optionally, the first actuating assembly comprises a gear arrangement.

Optionally, the gear arrangement comprises a worm gear configured to mesh with a corresponding track extending along a side of the container.

Optionally, the load handling device further comprises a second actuating assembly configured to stack upwards one or more containers following their retrieval from a container row such that another container from the container row can be accessed.

Optionally, the second actuating assembly comprises a pin for engaging a container, the pin being configured to move in an upward stroke to lift a container into a stackable position.

Optionally, the pin is further configured to move in a downward stroke to lower a container from the stackable position.

Optionally, the pin is retractable for disengaging a container.

Optionally, the pin is further configured to move in the upward and downward strokes when retracted.

Optionally, the load handling device further comprises a third actuating assembly configured to stack downwards one or more containers following their retrieval from a container row such that another container from the container row can be accessed.

Optionally, the third actuating assembly comprises a platform for holding one or more containers retrieved from a container row in a stacked arrangement, the third actuating assembly being configured to lower the platform such another container from the container row can be accessed.

Optionally, each container row comprises a plurality of containers configured to releasably interlock or engage with one another in a longitudinal direction, and the load handling device preferably comprises means for decoupling a container from or coupling a container to a container row as the first actuating assembly moves the container row lengthwise.

In a second aspect, the invention provides a load handling assembly for a container storage and retrieval system, the load handling assembly comprising a load handling device according to the first aspect.

Optionally, the load handling assembly comprises a lifting device engaged with the load handling device, the lifting device being configured to move the load handling device vertically such that the load handling device can access different rows of containers arranged in a vertical column.

Optionally, the lifting device comprises cables connected to the load handling device and one or more spool devices configured to extend and retract the cables in order to move the load handling device vertically.

Optionally, the load handling assembly is configured to enable the load handling device to move laterally so as to access rows of containers arranged in different vertical columns.

Optionally, the load handling assembly is configured to enable the load handling device to move longitudinally away from or towards the framework structure.

Optionally, the load handling assembly further comprises a first guide way comprising a cross member for guiding the lateral movement of the load handling device and/or a longitudinal member for guiding the longitudinal movement of the load handling device.

Optionally, the lifting device is configured to engage the cross member so as to guide the lateral movement of the load handling device and/or the longitudinal member so as to guide the longitudinal movement of the load handling device.

Optionally, the load handling assembly further comprises a second guide way comprising a cross member for guiding the lateral movement of the load handling device and/or a longitudinal member for guiding the longitudinal movement of the load handling device.

Optionally, the load handling assembly further comprises a base unit for supporting the lifting device, the base unit being configured to engage the cross member of the second guide way so as to guide the lateral movement of the load handling device and/or the longitudinal member of the second guide way so as to guide the longitudinal movement of the load handling device.

Optionally, the load handling assembly further comprises a support frame defining a channel for guiding the vertical movement of the load handling device.

Optionally, the load handling assembly further comprises a first row comprising a plurality of lifting devices and respective load handling devices, each lifting device being positioned such that its respective load handling device can access different rows of containers arranged in a vertical column.

Optionally, the load handling assembly further comprises a second row extending alongside the first row, the second row comprising at least one lifting device and a load handling device, the load handling assembly being configured such that the load handling device on the second row is able to move laterally so as to retrieve a container from or deliver a container to a load handling device on the first row.

In a third aspect, the invention provides a container storage and retrieval system comprising a frame structure configured to store a plurality of rows of containers, a workstation and a load handling assembly according to the second aspect.

In a fourth aspect, the invention provides a method of retrieving one or more target containers from a container storage and retrieval system according to the third aspect, the method comprising: moving a load handling device to a target container row; moving the target container row lengthwise using the load handling device to retrieve an end container from the target container row; determining if the retrieved container is the target container; and, moving the retrieved container using the load handling device to a temporary storage location if it is determined to be a non-target container; or, following a positive determination, moving the retrieved container out of the load handling device for delivery to a workstation.

Optionally, the method further comprises stacking upwards one or more non-target containers using the load handling device to allow access to the target container row.

Optionally, the method further comprises stacking downwards one or more non-target containers using the load handling device to allow access to the target container row.

Optionally, the method further comprises pushing the target container row or another row of containers using the load handling device to return one or more non-target containers.

In a fifth aspect, the invention provides a control system for a load handling assembly for a container storage and retrieval system comprising a frame structure configured to store a plurality of rows of containers, the control system comprising one or more controllers configured to: move a load handling device to a target container row; move the target container row lengthwise using the load handling device to retrieve an end container from the target container row; determine if the retrieved container is the target container; and, move the retrieved container using the load handling device to a temporary storage location if it is determined to be a non-target container; or, following a positive determination, move the retrieved container out of the load handling device for delivery to a workstation.

Preferably, the one or more controllers collectively comprise at least one electronic processor having an electrical input for receiving a target container position signal and a load handling device position signal and at least one memory device electrically coupled to the at least one electronic processor and having instructions stored therein, wherein the at least one electronic processor is configured to access the at least one memory device and execute the instructions thereon so as to determine a position of the target container row based on the target container position signal and select a load handling device for retrieving containers based on a difference between the positions of the target container row and the load handling device, as indicated by the load handling device position signal.

### BRIEF DESCRIPTION OF THE DRAWINGS

These and other aspects of the invention will now be described, by way of example only, and with reference to the accompanying drawings, in which:

FIG. 1 is a perspective view of a container storage and retrieval system comprising a load handling assembly according to an embodiment of the invention;

FIGS. 2a to 2c are perspective views of a load handling device of the load handling assembly of FIG. 1 at different locations within a vertical column of container rows;

FIGS. 3a to 3d show flow charts illustrating methods by which the load handling assembly of FIG. 1 retrieves one or more containers from a container row;

FIGS. 4a and 4b show a flow chart illustrating another method by which the load handling assembly of FIG. 1 retrieves one or more containers from a container row;

FIG. 5 is a schematic illustration of a simplified example of a control system such as may be adapted to implement the methods shown in FIGS. 3a to 3d, as well as FIGS. 4a and 4b;

FIGS. 6a to 6f provide several side views of a first actuating assembly of the load handling device of FIG. 2 and a container at various lateral positions;

FIGS. 7a to 7p provide several views illustrating the functionally of the first actuating assembly, as well as second and third actuating assemblies;

FIGS. 8a to 8d provide several different views illustrating the functionally of the first, second and third actuating assemblies;

FIG. 9 is a perspective view of the load handling device of FIG. 2 having accumulated several target containers;

FIGS. 10a to 10e show a coupling arrangement for containers;

FIG. 11 is a perspective view of another embodiment of a container storage and retrieval system;

FIG. 12 is an end view of the embodiment of the container storage and retrieval system of FIG. 11;

FIG. 13 is a perspective view of yet another embodiment of a container storage and retrieval system; and,

FIG. 14 shows an example of another application for the load handling device of FIG. 2.

In the figures, like features are denoted by like reference signs where appropriate.

### DETAILED DESCRIPTION

In the following description, some specific details are included to provide a thorough understanding of various disclosed embodiments. One skilled in the relevant art, however, will recognise that embodiments may be practiced without one or more of these specific details, or with other methods, components, materials, etc. In some instances, well-known structures associated with container storage and retrieval systems, such as processors, sensors, storage devices, network interfaces, workpieces, tensile members, fasteners, electrical connectors, mixers, and the like are not shown or described in detail to avoid unnecessarily obscuring descriptions of the disclosed embodiments.

Unless the context requires otherwise, throughout the specification and the appended claims, the word “comprise” and variations thereof, such as, “comprises” and “comprising” are to be construed in an open, inclusive sense that is as “including, but not limited to.”

Reference throughout this specification to “one”, “an”, or “another” applied to “embodiment”, “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification are not necessarily all referring to the same embodiment. Furthermore, the particular features, structures, or characteristics may be combined in any suitable manner in one or more embodiments, examples, or implementations.

It should be noted that, as used in this specification and the appended claims, the user forms “a”, “an”, and “the” include plural referents unless the content clearly dictates otherwise. Thus, for example, reference to a system including “a load handling device” includes a load handling device, or two or more load handling devices. It should also be noted that the term “or” is generally employed in its sense including “and/or” unless the content clearly dictates otherwise.

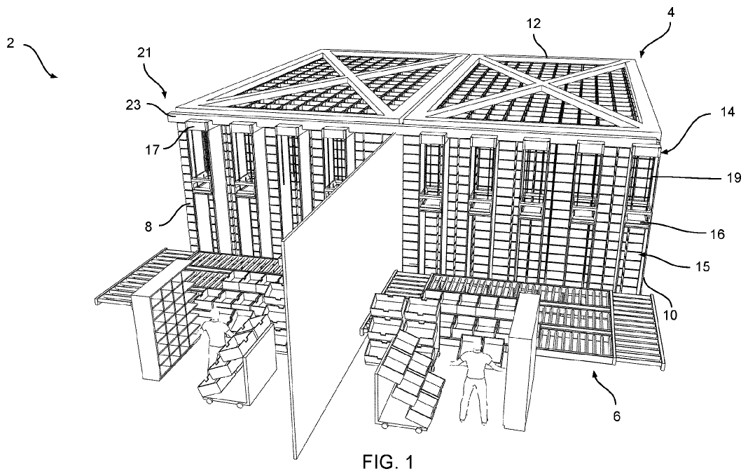

FIG. 1 is a perspective view of an embodiment of a container storage and retrieval system 2 according to an embodiment of the invention comprising a frame structure 4 and a workstation 6, together with a plurality of rows of containers 8 arranged within the frame structure 4. The frame structure 4 comprises a plurality of upright members 10 supporting a plurality of horizontal members 12, collectively defining the storage volume of the frame structure 4. In this embodiment, the container rows 8 are arranged in vertical columns, forming a plurality of columns of container rows 8. Each container row 8 sits on one or more substantially horizontal shelves (not shown) that form part of the frame structure 4. The shelves are configured to support a container row 8 and facilitate a lengthwise movement of the container row 8 towards or away from a load handling assembly 14, which also forms part of the container storage and retrieval system 2. In this embodiment, the load handling assembly 14 is positioned on one side 15 of the frame structure 4, between the frame structure 4 and the workstation 6, for facilitating the transfer of containers therebetween.

The load handling assembly 14 comprises at least one load handling device 16 that can be positioned adjacent to an end of a container row 8. The load handling device 16 comprises a first actuating assembly configured to move a container row 8 lengthwise either in order to retrieve one or more target containers from the container row 8 for delivery to the workstation 6 or add one or more containers received directly or indirectly from the workstation 6 to the container row 8. The load handling assembly 14 further comprises at least one lifting device 17 engaged with a respective load handling device 16 for moving the load handling device 16 vertically so that the load handling device 16 is able to access different rows of containers 8 within a column of container rows 8. In this example, the lifting device 17 comprises cables 19 that are connected to the load handling device 16 and one or more spool devices (not shown) that are arranged to extend and retract the cables 19 in order to move the load handling device 16 vertically up and down a column of container rows 8.

The load handling assembly 14 is further configured to allow the lateral movement of the load handling device 16 within a first substantially vertical plane extended in front of the side 15 of the frame structure 4 so that the load handling device 16 is able to access container rows 8 located within different columns of container rows 8. To that end, the load handling assembly 14, in this example, comprises a first guide way 21 comprising a substantially horizontal cross member 23 extending along the top of the side 15 of the frame structure 4 for guiding the lateral movement of the load handling device 16 within the first substantially vertical plane. Specifically, the lifting device 17 is configured to engage and run along the cross member 23 so as to guide the lateral movement of the load handling device 16 between columns of container rows 8.

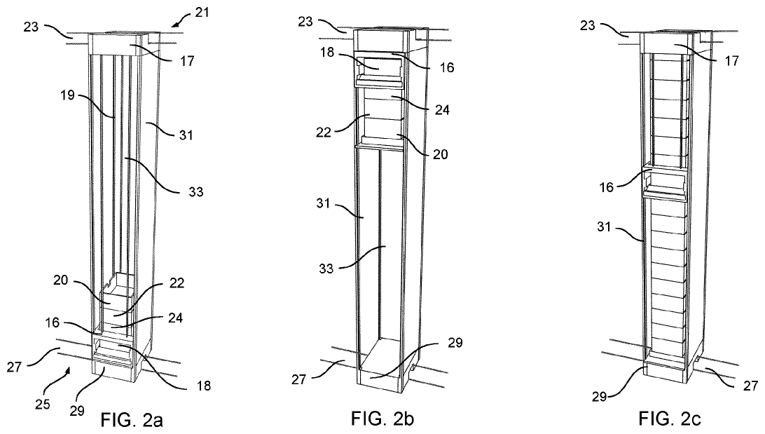

In this example, the load handling assembly 14 further comprises a second guide way 25 that, together with the first guide way 21, facilitates the lateral movement of the load handling device 16. Similar to the first guide way 21, the second guide way 25 comprises a substantially horizontal cross member 27 but extending along the bottom of the side 15 of the frame structure 4. The cross member 27 of the second guide way 25 carries a base unit 29, which can be seen in FIG. 2a, together with a section of the cross member 27. The base unit 29 is configured to engage and run along the cross member 27 in order to facilitate the lateral movement of the load handling device 16, and is connected to the lifting device 17 by a support frame 31 extending substantially vertically therebetween. The support frame 31 defines a channel 33 that functions to guide the vertical movement of the load handling device 16, as provided by the lifting device 16, and minimise lateral drift as the load handling device 16 is moved laterally. That is, the channel 33 partly functions to mitigate or dampen the inertial effects on the load handling device 16 during its lateral movement.

In general, when retrieving a target container from a container row 8, the load handling device 16 is first moved to an end of the container row 8 that includes the target container i.e., a target container row 8. From there, the first actuating assembly causes the target container row 8 to move substantially longitudinally in a direction towards the load handling device 16 so that a container at the end of the target container row 8 i.e., the end container, is laterally received therein. If, on one hand, the end container is the target container, the first actuating assembly moves the end container out of the load handling device 16 for delivery to the workstation 6. If, on the other hand, the end container is a non-target container, it is moved by an additional actuating assembly to a temporary storage location outside the frame structure 4, freeing up space within the load handling device 16 for the receipt of another container from the target container row 8. The container row 8 continues its iterated longitudinal movement, as enabled by the first actuating assembly, until the next container, which now defines the end of the container row 8, is received within the load handling device 16. From here, this container, provided that it is the target container, is moved by the first actuating assembly out of the load handling device 16 for delivery to the workstation 6, otherwise it is moved to the temporary storage location outside the frame structure 4. The load handling device 16 is configured to perform these functions iteratively until the target container has been retrieved from the target container row 8. Following the retrieval and delivery of the target container, the non-target containers are then individually moved from the temporary storage location by the other actuating assembly into the load handling device 16 for delivery by the first actuating assembly back into the target container row 8 or another container row 8 depending on, amongst other factors, the availability of space, the preferred sequence by which the non-target containers are returned to the container rows 8, etc. In this generalised example of the load handling assembly 14, the load handling device 16 is configured to retrieve target containers from target container rows 8 so they can be delivered individually to the workstation 6 in a step-by-step manner. In another example, the load handling device 16 may be configured to accumulate target containers in a temporary storage location following their retrieval for “bulk” delivery to the workstation 6. In this example, target and non-target containers would be held in different temporary storage locations.

Containers from the workstation 6 may also be added to a container row 8 in a way similar to their retrieval from a container row 8. In this instance, a container from the workstation 6 is received by the load handling device 16, as enabled by the first actuating assembly. The load handling device 16 then moves to the container row 8 to which the container from the workstation 6 is to be added. From here, the first actuating assembly pushes the container from the load handling device 16 into the end of the container row 8, displacing the container row 8 lengthwise, away from the load handling device 16, and freeing up space within the frame structure 4 for the addition of the container.

FIGS. 2a to 2c are perspective views of a load handling device 16 at different locations within a vertical column of container rows 8, although the container rows 8 are not shown in this instance for reasons of clarity. In FIG. 2a, the load handling device 16 is positioned to access a target container row at the bottom of the vertical column with the aim of retrieving a target container 18, the target container 18 being the fourth container from the end of the target container row 8 whereas the first three containers in the target container row are non-target containers. As described above, the first actuating assembly causes the target container row to move longitudinal until a first non-target container 20 of the three non-target containers is received within the load handling device 16. From here, a second actuating assembly, which forms part of the load handling device 16, engages the first non-target container 20 and lifts it into a temporary storage location extending above the load handling device 16, making space available in the load handling device 16 for the receipt of a second non-target container 22. The first actuating assembly causes the target container row to move longitudinally, resulting in the receipt of the second non-target container 22 within the load handling device 16. From here, the second actuating assembly enables an engagement between the first and second non-target containers 20, 22, forming an upward accumulation or stack of non-target containers. The second actuating assembly then engages the second non-target container 22 and lifts it, together with the first non-target container 20, into the temporary storage location, making room available within the load handling device 16 for the receipt of a third non-target container 24. As with the first and second non-target containers 20, 22, the first actuating assembly enables movement of the target container row lengthwise towards the load handling device 16 such that the third non-target container 24 is received by the load handling device 16. With the third non-target container 24 in position below the second non-target container 22, the second actuating assembly disengages the second non-target container 22, bringing the bottom of the second non-target container 22 into engagement with the top of the third non-target container 24, and engages the third non-target container 24 and lifts it, together with the first and second non-target containers 20, 22, into the temporary storage location extending above the load handling device 16. This clears space within the load handling device 16 for the target container 18, the delivery of which is provided by the first actuating assembly for the subsequent delivery to the workstation 6. Following delivery of the target container 18 to the workstation 6, the first and second actuating assemblies work in reverse to return the non-target containers 20, 22, 24 to the target container row 8. That is, the second actuating assembly lowers the third non-target container 24 into the load handling device 16. The second actuating assembly then disengages with the third non-target container 24, and engages with the second non-target container 22 and lifts it clear of the third non-target container 24. The first actuating assembly then pushes the third non-target container 24 into the end of the target container row 8, displacing it longitudinally away from the load handling device 16 in order to provide space within the frame structure 4 for the return of the third non-target container 24. Following this, the first and second non-target containers 20, 22 are also returned to the target container row 8 in a similar manner, as provided by the first and second actuating assemblies.

The target container row 8 is in a low position within the vertical column in the previous example, and so the load handling device 16 is configured to stack upwardly the non-target containers 20, 22, 24 using the second actuation assembly to enable retrieval of the target container 18. In the opposite situation, when the target container row 8 is in a high position within the vertical column, the load handling device 16 uses a third actuating assembly for stacking non-target containers in a downwards direction following their retrieval from the target container row, as shown in FIG. 2b. In this example, the positions of the target and non-target containers 18, 20, 22, 24 within the target container row are the same as in the previous example shown in FIG. 2a. That is, the non-target containers 20, 22, 24 occupy the first three positions within the target container row 8, while the target container 18 occupies the fourth position, meaning that the non-target containers 20, 22, 24 need to be moved before the target container 18 can be accessed. To that end, the first actuating assembly causes the target container row 8 to move lengthwise until the first non-target container 20 is received within the load handling device 16. From here, the first non-target container 20 is brought into engagement with the third actuating assembly, which lowers it to make space available in the load handling device 16 for the receipt of the second non-target container 22. The first actuating assembly causes the target container row 8 to move longitudinally resulting in the receipt of the second non-target container 22 within the load handling device 16. The first and second non-target containers 20, 22 are then brought into engagement, with the second non-target container 22 being positioned above the first non-target container 20, such that the third actuating assembly bears the weight of both containers 20, 22. The third actuating assembly then lowers the first and second non-target containers 20, 22, making way for the receipt of the third non-target container 24. This sequence of steps is then repeated for the third non-target container 24. That is, its lateral receipt into the load handling device 16 from the target container row 8 is enabled by the first actuating assembly. Following this, the bottom of the third non-target container 24 is brought into contact with the top of the second non-target container 22, so that the third actuating assembly bears the combined weight of all three non-target containers 20, 22, 24, and the third actuating assembly then lowers the stack of the first, second and third non-target containers 20, 22, 24, making space available for the receipt of the target container 18 within the load handling device 16, as provided by the first actuating assembly, for the subsequent delivery to the workstation 6. Following delivery of the target container 18 to the workstation 6, the first and third actuating assemblies work in reverse to return the non-target containers 20, 22, 24 to the target container row 8. That is, the third actuating assembly raises the stack so the third non-target container 24 is received within the load handling device 16. The third non-target container 24 is then disengaged from the second non-target container 22 and the first actuating assembly pushes the third non-target container 24 into the end of the target container row 8, displacing it longitudinally away from the load handling device 16 in order to provide space within the frame structure 4 for the return of the third non-target container 24. Following this, the first and second non-target containers 20, 22 are also returned to the target container row 8 in a similar manner, as provided by the first and third actuating assemblies.

In a situation where the target container row is centrally located within a vertical column, the load handling device 16 is configured to accumulate non-target containers upwards and downwards, using the first, second and third actuating assemblies as described above, in order to access a target container, as shown in FIG. 2c.

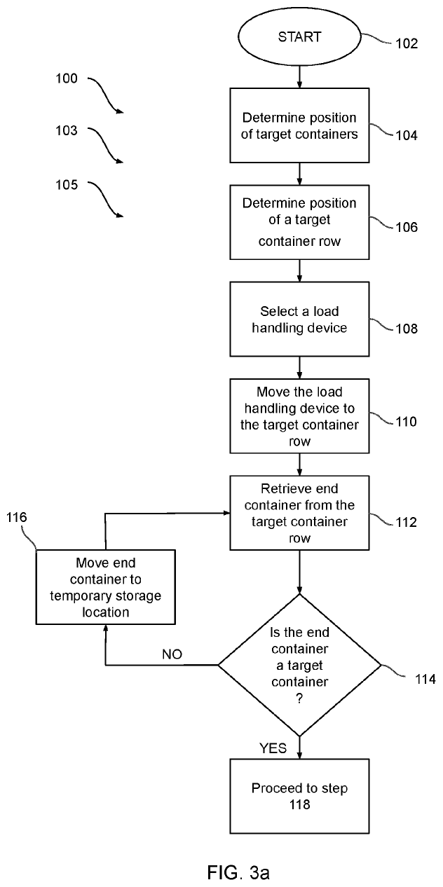

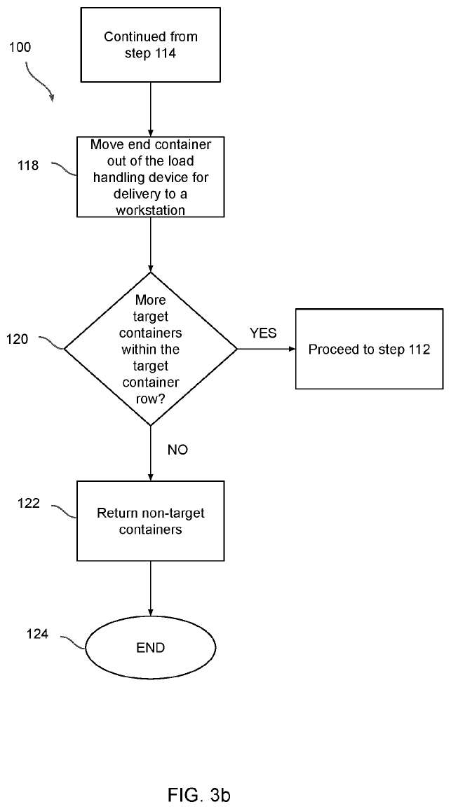

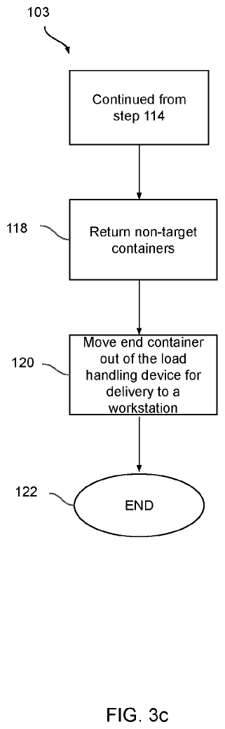

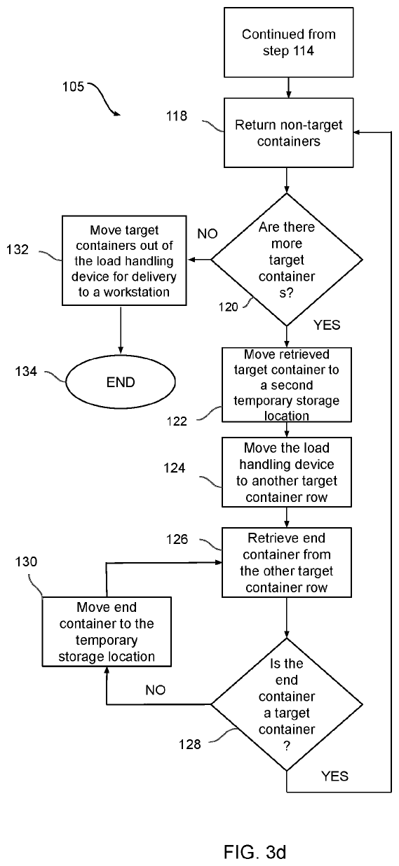

FIGS. 3a and 3b show a flow chart illustrating an example method 100 by which the load handling assembly 14 retrieves one or more target containers 18 from a target container row 8. The method starts at step 102 and continues to step 104 where the locations of the target containers 18 are determined using a three coordinate system (x, y, z), indicating the column in which the target container 18 is held (x), its height within the column (y), and its depth within a container row (z). At step 106, the coordinates (x, y) of a target container row 8 is then determined based on the coordinates (x, y, z) of one or more of the target containers 18. The method 100 then continues to step 108 where a load handling device 16 is selected based on the coordinates (x, y) of the target container row 8. Following its selection, the load handling device 16 is moved, at step 110, to the end of the target container row 8 based on the coordinates (x, y) determined at step 106 and moves the target container row 8 laterally to retrieve a first end container at step 112. It is then determined, at step 114, whether the first end container is one of the target containers 18 identified in step 104 based on its original coordinates (x, y, z) within the frame structure 4 when compared to the coordinates (x, y, z) of the one or more target containers 18. If it is determined that the first end container is a non-target container, the method 100 continues to step 116, where the first end container is moved to a temporary storage location as described above, and then back to step 112, where the load handling device 16 moves the target container row 8 to retrieve a second end container. The method 100 iterates through steps 112, 114 and 116 until it is determined, at step 114, that the retrieved container is a target container 18. In this instance, if it is determined that the second end container is a target container 18 at step 114, the method 100 continues to step 118 (see FIG. 3b) where the second end container is moved out of the load handling device 16 for delivery to a workstation 6. From here, the method 100 continues to step 120 where it is determined whether there are more target containers 18 within the target container row 8 based on a comparison between the coordinates (x, y) of the target container row 8 and the coordinates (x, y, z) of the one or more target containers 18. If it is determined that there are more target containers 18 within the target container row 8, the method 100 cycles back to step 112 for the load handling device 16 to retrieve a third end container. If, however, it is determined, at step 120, that there are no more target containers 18 within the target container row 8, the method 100 continues to step 122 where any non-target containers, such as the first end container in this example, are returned by the load handling device 16 to the target container row 8, following which, the method 100 is ended at step 124.

FIGS. 3a and 3c show a flow chart illustrating another example method 103 by which the load handling assembly 14 retrieves one or more target containers 18 from a target container row 8. Like the previous method, this method 103 starts at step 102 and continues to step 104 where the locations of the target containers 18 are determined using a three coordinate system (x, y, z), indicating the column in which the target container 18 is held (x), its height within the column (y), and its depth within a container row (z). At step 106, the coordinates (x, y) of a target container row 8 is then determined based on the coordinates (x, y, z) of one or more of the target containers 18. The method 103 then continues to step 108 where a load handling device 16 is selected based on the coordinates (x, y) of the target container row 8. Following its selection, the load handling device 16 is moved, at step 110, to the end of the target container row 8 based on the coordinates (x, y) determined at step 106 and moves the target container row 8 laterally to retrieve a first end container at step 112. It is then determined, at step 114, whether the first end container is one of the target containers 18 identified in step 104 based on its original coordinates (x, y, z) within the frame structure 4 when compared to the coordinates (x, y, z) of the one or more target containers 18. If it is determined that the first end container is a non-target container, the method 103 continues to step 116, where the first end container is moved to a temporary storage location as described above, and then back to step 112, where the load handling device 16 moves the target container row 8 to retrieve a second end container. The method 103 iterates through steps 112, 114 and 116 until it is determined, at step 114, that the retrieved container is a target container 18. In this instance, if it is determined that the second end container is a target container 18 at step 114, the method 103 continues to step 118 (see FIG. 3c) where any non-target containers are returned by the load handling device 16 to the target container row 8 or a different container row 8. From here, the method 103 proceeds to step 120 where the second end container is moved out of the load handling device 16 for delivery to a workstation 6, following which, the method 103 is ends at step 124.

FIGS. 3a and 3d show a flow chart illustrating yet another example method 105 by which the load handling assembly 14 retrieves one or more target containers 18 from a target container row 8. As with the previous methods, this method 105 starts at step 102 and continues to step 104 where the locations of the target containers 18 are determined using a three coordinate system (x, y, z), indicating the column in which the target container 18 is held (x), its height within the column (y), and its depth within a container row (z). At step 106, the coordinates (x, y) of a target container row 8 is then determined based on the coordinates (x, y, z) of one or more of the target containers 18. The method 105 then continues to step 108 where a load handling device 16 is selected based on the coordinates (x, y) of the target container row 8. Following its selection, the load handling device 16 is moved, at step 110, to the end of the target container row 8 based on the coordinates (x, y) determined at step 106 and moves the target container row 8 laterally to retrieve a first end container at step 112. It is then determined, at step 114, whether the first end container is one of the target containers 18 identified in step 104 based on its original coordinates (x, y, z) within the frame structure 4 when compared to the coordinates (x, y, z) of the one or more target containers 18. If it is determined that the first end container is a non-target container, the method 105 continues to step 116, where the first end container is moved to a temporary storage location as described above, and then back to step 112, where the load handling device 16 moves the target container row 8 to retrieve a second end container. The method 105 iterates through steps 112, 114 and 116 until it is determined, at step 114, that the retrieved container is a target container 18. In this instance, if it is determined that the second end container is a target container 18 at step 114, the method 105 continues to step 118 (see FIG. 3d) where any non-target containers are returned by the load handling device 16 to the target container row 8 or a different container row 8. From here, the method 105 proceeds to step 120 where it is determined if there are any more target containers 18 to be retrieved. If so, the method 105 continues to step 122 where the first target container 18 is moved to a second temporary storage location. From there, the load handling device 16 is moved to the container row containing the other target container 18 at step 124. Once there, the load handling device 16 moves the other target container row 8 laterally to retrieve the end container at step 126. It is then determined, at step 128, whether the end container is one of the target containers 18 identified in step 104 based on its original coordinates (x, y, z) within the frame structure 4 when compared to the coordinates (x, y, z) of the one or more target containers 18. If it is determined that the first end container is a non-target container, the method 105 continues to step 130, where the end container is moved to the temporary storage location as described above, and then back to step 126, where the load handling device 16 moves the target container row 8 to retrieve a second end container. The method 105 iterates through steps 126, 128 and 130 until it is determined, at step 128, that the retrieved container is a target container 18. From here, the method 105 cycles back to step 118 where any non-target containers are returned to the container rows 8 and then it is determined at step 120 if there are any more target containers 18 to be retrieved. If so, the method 105 continues to cycle through steps 118, 120, 122, 124, 126, 128 and 130 until all of the target containers 18 have been retrieved, following which, the method 105 then moves onto step 132 where the target containers 18 are moved out of the load handling device 16 for delivery to a workstation. Following this, the method 105 ends at step 134.

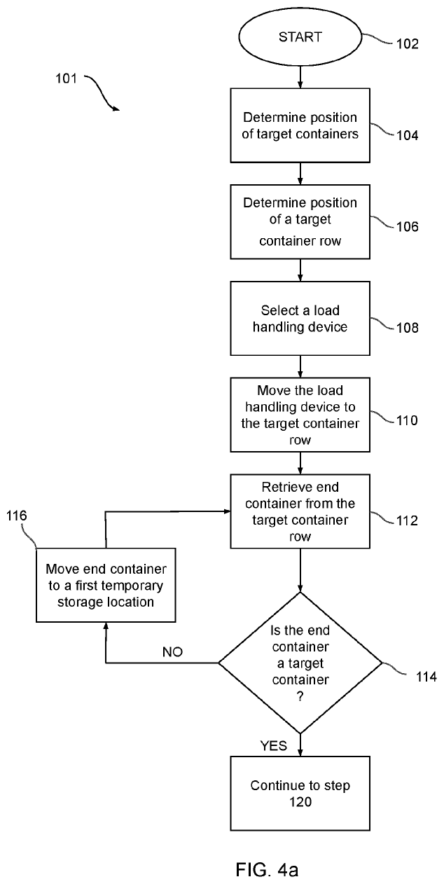

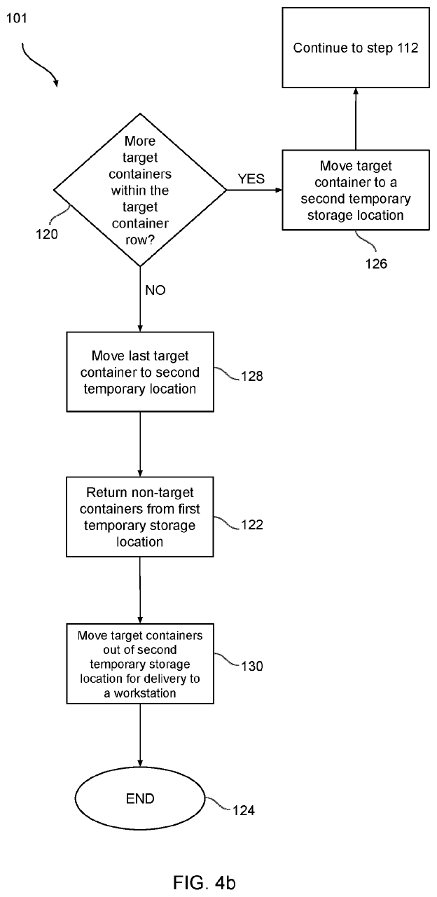

FIGS. 4a and 4b show a flow chart illustrating yet another example method 101 by which the load handling assembly 14 retrieves one or more target containers 18 from a target container row 8. This method 101 enables the accumulation of target containers 18 for bulk delivery to a workstation 6, and is the same as the previous method 100 up to step 114, where it is determined whether the first end container is one of the target containers 18 identified in step 104 based on its original coordinates (x, y, z) within the frame structure 4 when compared to the coordinates (x, y, z) of the one or more target containers 18. If it is determined that the first end container is a non-target container, the method 101 continues to step 116, where the first end container is moved to a first temporary storage location as described above, and then back to step 112, where the load handling device 16 moves the target container row 8 to retrieve a second end container. The method 101 cycles through steps 112, 114 and 116, such that the load handling device 16 accumulates any containers identified as non-target containers within the first temporary storage location, until it is determined, at step 114, that a retrieved container is a target container 18. In this instance, if it is determined that the second end container is a target container 18 at step 114, the method 101 continues to step 120 where it is determined if there are more target containers 18 within the target container row 8 based on a comparison between the coordinates (x, y) of the target container row 8 and the coordinates (x, y, z) of the target containers 18. If it is determined that there are more target containers 18 within the target container row 8, the method 101 continues step 126 where the target container 18 is moved to a second temporary storage location, the second temporary storage location being different to the first temporary storage location, such that target and non-target containers can be accumulated in separate temporary storage locations. The method 101 keeps iterating through steps 112, 114, 116, 120 and 126, separately accumulating target and non-target containers, until it is determined at step 120 that there are no more target containers 18 within the target container row 8. From here, the method 101 continues to step 128, where the final target container 18 is moved to the second temporary storage location, and then to step 122, where the load handling device 16 returns the non-target containers to the target container row 8. In this and the previous methods, the non-target containers can be returned to the target container row 8 in the same order as they were retrieved or in a different order, possibly to occupy different container rows 8. The accumulated target containers 18 are then moved out of the second temporary storage location by the load handling device 16, at step 130, for bulk delivery to a workstation 6, following which the method 101 is ended at step 124.

Other methods are also envisaged, such as ones that use a search tree algorithm to determine a route by which the load handling assembly 14 retrieves one or more target containers 18 from the container rows 8.

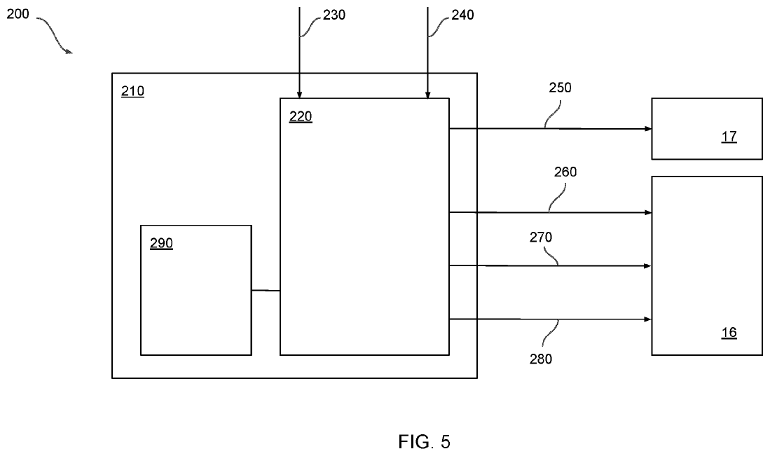

With reference to FIG. 5, there is illustrated a simplified example of a control system 200 such as may be adapted to implement the methods of FIGS. 3a to 3d, and FIGS. 4a and 4b described above. The control system 200 comprises one or more controllers 210 generally configured to retrieve one or more target containers from a target container row by: moving a load handling device 16 to an end of the target container row 8; moving the target container row 8 lengthwise using the load handling device 16 to retrieve an end container therefrom; determining if the retrieved container is the target container; moving the retrieved container using the load handling device 16 to a temporary storage location if it is determined to be a non-target container; or, in the event it is determined to be the target container, moving the retrieved container out of the load handling device 16 for delivery to a workstation 6.

In the example illustrated in FIG. 5, the controller 210 comprises at least one electronic processor 220 having one or more electrical inputs for receiving a target container position signal 230, indicative of the position of at least one target container 18 within the frame structure 4 based on the three coordinate system (x, y, z), and a load handling device position signal 240, indicative of the positions of the load handling devices 16 in a two coordinate system (x, y) within the first substantially vertical plane extended in front of the side 15 of the frame structure 4. The electronic processor 220 further comprises one or more electrical outputs for outputting one or more of a drive control signal 250 and first, second and third actuator control signals 260, 270, 280 for controlling the first, second and third actuating assemblies respectively. The controller 210 further comprises at least one memory device 290 electrically coupled to the at least one electronic processor 220 and having instructions stored therein. The electronic processor 220 is configured to access the at least one memory device 290 and execute instructions thereon so as to determine the position of the target container row 8 based on the first two coordinates (x, y) of the target container 18 (x, y, z), as indicated by the target container position signal 230, and select a load handling device 16 based on a difference in the positions of the target container row 8 and the load handling devices 16, as indicated by the load handling device position signal 240. In an example, a load handling device 16 closest to the target container row 8 may be selected. The electronic processor 220 then outputs the drive control signal 250 for moving the selected load handling device 18 to the end of the target container row 8. In this example, the drive control signal 250 is received by the lifting device 17 for moving the load handling device 16 laterally and vertically as necessary to the end of the target container row 8. The electronic processor 220 is configured to output the first actuator control signal 260 causing the load handling device 16 to move the target container row 8 lengthwise to retrieve an end container or to move a retrieved container that has been determined to be a target container 18 out of the load handling device 16 for delivery to a workstation 6. The electronic processor 220 determines whether a retrieved container is one of the target containers 18 based on its original coordinates (x, y, z) within the frame structure 4 when compared to the coordinates (x, y, z) indicated in the target container position signal 230. The electronic processor 220 is further configured to output the second or third actuator control signal 270, 280 to the load handling device 16 to hold any retrieved containers identified as non-target containers in a temporary storage location as provided by second and third actuating assemblies. Alternatively, the electronic processor 220 is configured to output the one of the second or third actuator control signals 270, 290 to hold containers identified as non-target containers in the first temporary storage location and output the other of the second or third actuator control signals 270, 290 to hold those containers identified as target containers 18 in the second temporary storage location.

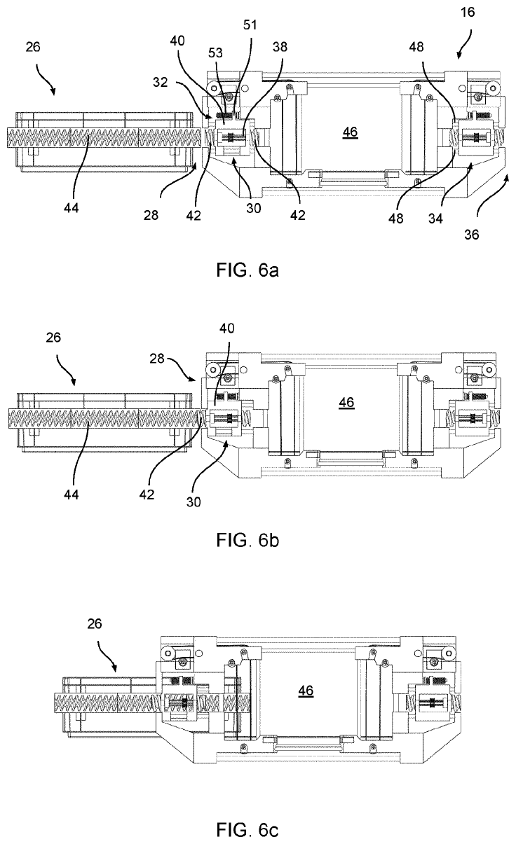

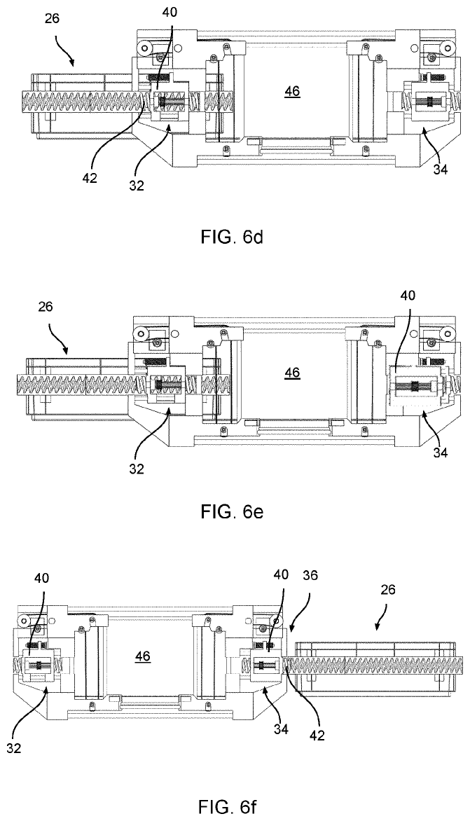

An example of the first actuating assembly is illustrated in FIGS. 6a to 6f, which provide a number of side views of a load handling device 16 and an end container 26 at various lateral positions as it is being driven by the first actuating assembly into and out from the load handling device 16. FIG. 6a shows a situation in which the load handling device 16 has been moved into position adjacent to the container 26, which is located within the frame structure 4, at end of a target container row 8. The first actuating assembly, generally designated by 30, is in essence a linear actuator, which, in this example, comprises first and second actuating members 32, 34 for moving containers between the first end 28 and a second end 36 of the load handling device 16. For ease of understanding, only two actuating members 32, 34 are shown, each being associated with a respective end 28, 36 of the load handling device 16, but the skilled reader will understand that it is preferable, albeit not essential, that each end 28, 36 of the loading handling device 16 is associated with a pair of actuating members capable of being actuated simultaneously. In this example, the first actuating assembly comprises a gear arrangement. Specifically, the first and second actuating members 32, 34 each comprise a substantially horizontal shaft 38 operatively connected to a first electric motor (not shown) for rotating the shaft 38 about its longitudinal axis. Each shaft 38 is rotatably mounted to a respective support frame 40 and carries two worm gears 42 at either end. The worm gears 42 are configured to mesh with a corresponding track 44 or thread extending longitudinally along a side of the container 26 such that the rotational motion of a worm gear 42 when engaged with the track 44 is converted to a linear push/pull movement of the container 26 to pull or push the container 26 into or out from a cavity 46 within the load handling device 16. The support frame 40, onto which the shaft 38 is rotatably mounted, is carried on a linear guide in the form of slide rails 48 and is driven on the slide rails 48 by a second electric motor (not shown) to facilitate changes to its lateral position with respect to the slide rails 48. Specifically, in this embodiment, the support frame 40 comprises a travelling nut 51 configured to move along a corresponding lead screw 53 as the lead screw 53 is rotated clockwise or anticlockwise by the second electric motor, converting the rotational motion of the lead screw 53 to a linear motion of the support frame 40.

As described above, the first actuating assembly is configured to move a container row lengthwise either in order to retrieve one or more target containers from a target container row, for delivery to the workstation, or add one or more containers from the workstation to the target container row. To this end, the containers forming the container rows are configured to releasably interlock or engage with one another in a longitudinal direction, forming a series of containers connected in an end-to-end arrangement, such that when the end container 26 is pulled into or pushed from the load handling device 16 by the first actuating assembly, the whole container row is pulled or pushed along with it. Accordingly, the first actuating assembly is capable of moving a container row, which is done in this example through its engagement with the end container 26.

Turning to FIG. 6b, in order to engage the container 26, the support frame 40 of the first actuating member 32 is driven by the second electric motor in a first direction from a neutral position towards the container 26, causing a worm gear 42 to project from the first end 28 of the load handling device 16. During this movement, the worm gear 42 is rotatably driven, by the first electric motor, into engagement with the track 44. In order to overcome the static friction between the worm gear 42 and the track 44 during this initial engagement, the first electric motor maybe overdriven for a short duration so that it produces more torque than its nominal rating, which is used while the container 26 is moving. This ability to overdrive the first electric motor above its nominal rating provides temporary access to greater torque, avoiding the need for a larger motor. From here, the continued rotation of the worm gear 42 pulls the container 26 into the cavity 46, as shown in FIG. 6c, and the rest of the container row is pulled along with the container 26 towards the load handling device 16. With reference to FIG. 6d, before the container 26 is received fully within the cavity 46 and while the first actuating member 32 is engaged with the track 44, the support frame 40 of the first actuating member 32 is driven laterally in a second direction past its neutral position towards the second actuating member 34, the second direction being opposite to the first direction. At the same or a similar time, the support frame 40 of the second actuating member 34 is driven laterally in the first direction from its neutral position towards the first actuating member 32, minimising the distance between the first and second actuating members 32, 34. The distance defined between the first and second actuating members 32, 34 at this point is less than the length of the container 26, ensuring that the first and second actuating members 32, 34 are positioned so as to be able to engage, and so provide support to, both ends of the container 26 during its lateral transition through load handling device 16. From here, the first actuating member 32 continues to drive the container 26 into the cavity 46 and engagement with the second actuating member 34, as shown in FIG. 6e. The load handling device 16 comprises means (not shown) for decoupling a container from a container row 8 as the first actuating assembly moves a container row lengthwise such that as an end 49 of the container 26 that it used to connect the container 26 to the container row 8 passes the first end 28 of the load handling device 16, the container 26 disengages from the container row 8, leaving the subsequent container within the container row adjacent to the first end 28 of the load handling device 16 for the subsequent engagement by the first actuating assembly. The first and second actuating members 32, 34 continue to drive the container 26 laterally through the cavity 46 of the load handling device 16 until such a point that the container 26 disengages the first actuating member 32, leaving the second actuating member 34 as the sole driver of the container 26. From here, the support frame 40 of the first actuating member 32 is returned to its neutral position and, at the same or a similar time, the support frame 40 of the second actuating member 34 is driven in the second direction away from the first actuating member 32 such that a worm gear 42 of the second actuating member 34 protrudes from the second end 36 of the load handling device 16, as shown in FIG. 6f. From here, the second actuating member 34 drives the container 26 out of the load handling device 16 for delivery to a workstation 6. It is in this way that the first actuating means is able to laterally transfer a target container from a target container row for delivery to a workstation.

In order to transfer a container that has come from a workstation to a container row within the frame structure 4, the process described above is carried out in reverse. That is, the support frame 40 of the second actuating member 34 moves from its neutral position in the second direction away from the first actuating member in order to engage the track 44 of a container positioned adjacent to the second end 36 of the load handling device 16. From here, the second actuating member 34 drives the container into the cavity 46 of the load handling device 16 and the support frame 40 of the second actuating member 34 is moved in the first direction towards the first actuating member 32, which itself is driven in the second direction towards the second actuating member 34 for engagement with the container 26. After engaging the track 44 of the container 26, the support frame 40 of the first actuating member 32 is moved in the first direction away from the second actuating member 34 and drives the container 26 to the first end 28 of the load handling device 16 where the container 26 engages the end of the container row 8 to which it is being added. At this stage, the means for decoupling a container from a container row may also function in reverse to couple a container to a container row, such that as the end 49 of the container 26 passes the first end 28 of the load handling device, it interlocks with the container at the end of the container row 8. From here, the container row 8 is displaced lengthwise away from the load handling device 16 in order to make space sufficient to accommodate the container 26 through the continued lateral movement of the container 26 as provided by the first actuating member 32.

As has already been mentioned, the first actuating assembly is configured to enable movement of a container row 8 lengthwise in order to retrieve a container from or add a container to a container row 8. In the example given above, because the shelves on which the container rows 8 sit are substantially horizontal, the first actuating assembly either engages an end container to pull it and its container row 8 towards the load handling device 16 or pushes a container into a container row 8, displacing it away from the load handling device 16. Here for interfaces In order to facilitate the lengthwise movement of a container row 8, the containers and the shelves upon which they sit may comprise cooperating flat surfaces, forming a linear bearing. In another example, the containers may comprise a plurality of wheels arranged to engage the shelves, enabling the displacement of the container row 8 towards or away from the load handling device 16. In either of these examples, and in other examples, the shelves made be arranged to be upwardly inclined away from the load handling assembly 14, as opposed to being arranged substantially horizontally, such that the container row 8 is driven towards a load handling device under gravitational force, removing the need for end-to-end coupling of the containers. In this example, the first actuating assembly may comprise a gate mechanism or the like, which, upon activation, causes the container row 8 to move under gravitational force in order to retrieve a container therefrom. A linear actuator or similar could then be used to push a container into a container row 8, against gravitational force, in order to add the container to the container row 8. In all examples, the first actuating assembly enables an iterative or container-by-container movement of the container row 8 so that a subsequent container can be accessed for retrieval by the first actuating assembly following the retrieval of an earlier container.

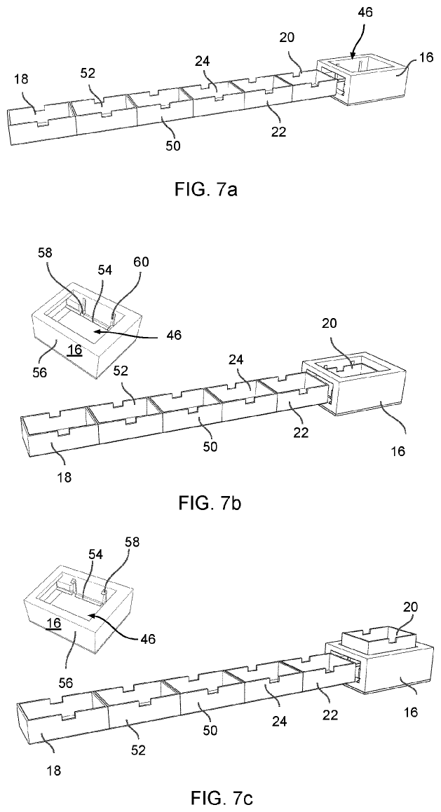

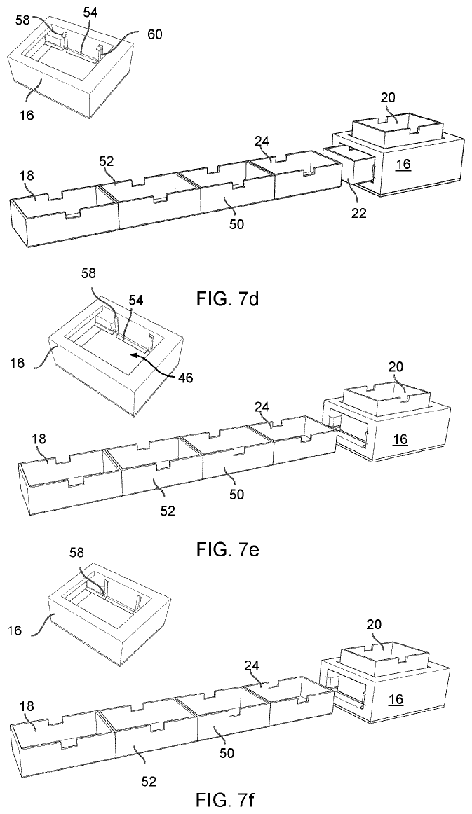

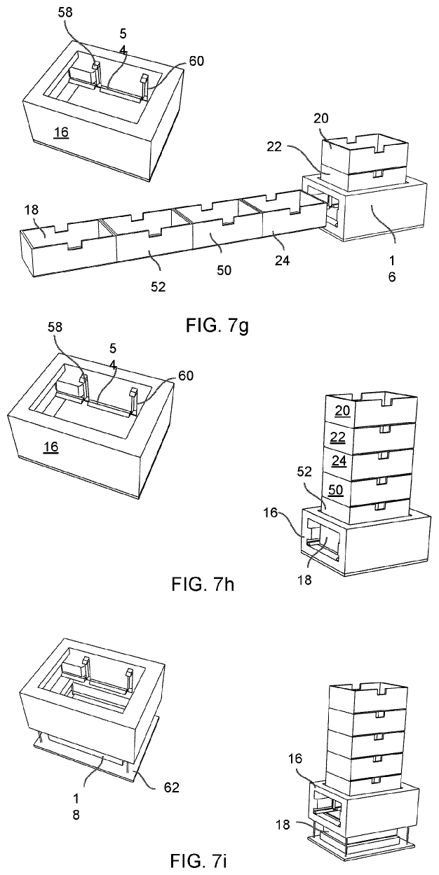

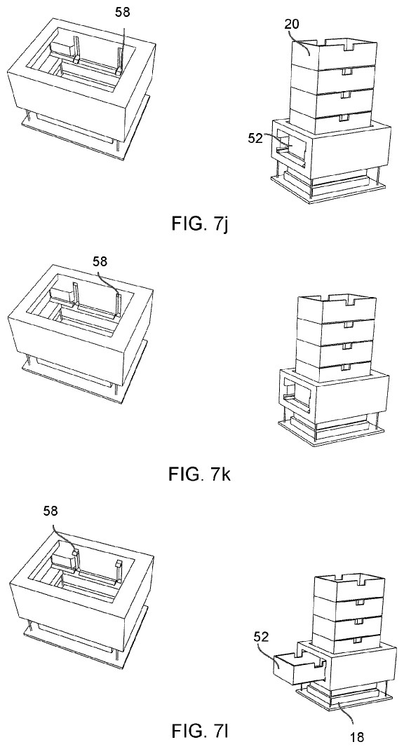

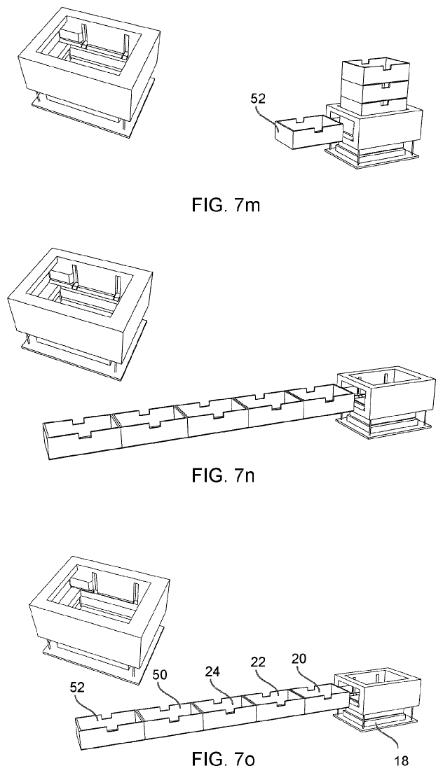

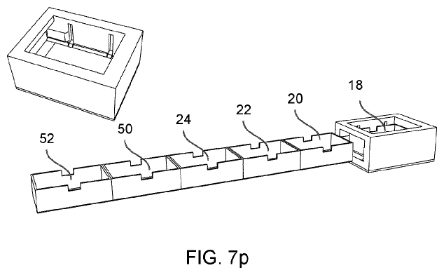

FIGS. 7a to 7p provide an example of how the first, second and third actuating assemblies work in combination with each other in order to retrieve a target container from a target container row 8. These figures show the load handling device 16 without many features, such as the first actuating assembly, in order not to obfuscate the features and functionally of the second and third actuating assemblies. With reference to FIG. 7a, in this instance, the target container 18 is located at the far end of a target container row 8 comprising five non-target containers 20, 22, 24, 50, 52 positioned between it and a load handling device 16. The first non-target container 20 is pulled into the cavity 46 of the load handling device 16 by the first actuating assembly as described above and as shown in FIG. 7b. The load handling device 16 comprises retractable rails 54 upon which a container sits when it is held within the cavity 46. The retractable rails 54 extend within the cavity 46, along the longitudinal sides 56 of the load handling device 16, and are intersected by four retractable pins 58 that comprise part of the second actuating assembly, with only two pins 58 on one side of the cavity 46 being shown in the figures. The pins 58 are configured to engage a container held within cavity 46 and move under the control of a third electric motor (not shown) within respective guides 60 in an upwards stoke, from a lowermost position to an uppermost position, to lift the container into a temporary storage location or stackable position above the cavity 46, and from the uppermost position to the lowermost position, in a downward stroke, to lower the container from the temporary storage location into the cavity 46. Turning to FIG. 7c, in order to make space in the cavity 46 for the second non-target container 22, the first non-target container 20 is lifted out of the cavity 46 by the pins 58 into a temporary storage location above the cavity 46. The pins 58 then hold the first non-target container 20 above the cavity 46 while the second non-target container 22 is pulled into the cavity 46 by the first actuating assembly, as shown in FIG. 7d. Once the second non-target container 22 is within the cavity 46, the pins 58 then retract into their respective guides 60 so as to disengage the first non-target container 20, as shown in FIG. 7e. Without the support of the pins 58, the bottom of the first non-target container 20 is brought into contact with the top of the second non-target container 22 in a stacked arrangement. The pins 58 then travel in their retracted position in the downward stroke from the uppermost position to the lowermost position. Once in the lowermost position, the pins 58 move from their retracted position to their extended position in order to engage the second non-target container 22, as shown in FIG. 7f. Turning to FIG. 7g, the pins 58 then lift the second non-target container 22 out of the cavity 46 and in doing so moves the first and second non-target containers 20, 22 into the temporary storage location above the cavity 46, making space available within the cavity for receipt of the third non-target container 24. The first and second actuating assemblies continue to cooperate in this iterative manner until all five non-target containers 20, 22, 24, 50, 52 are held above the cavity 46 by the second actuating assembly in a stacked arrangement, and the target container 18 is held within the cavity 46 having been moved there by the first actuating assembly, as shown in FIG. 7h. From here, the retractable rails 54 retract allowing the target container 18 to rest directly on a platform 62 that forms the base of the load handling device 16. The platform 62 forms part of the third actuating assembly and is configured to be lowered from its position at the base of the load handling device 16, away from the cavity 46, to hold one or more containers in a temporary storage location extending below the cavity 46, freeing up the cavity 46 so that another container from a container row can be assessed, for example. Turning to FIG. 7i, whilst the non-target containers 20, 22, 24, 50, 52 are being held by the second actuating assembly above the cavity 46, the target container 18 is then lowered from the cavity 46 by the third actuating assembly, making space available within the cavity 46, and the retractable rails 54 are returned to their extended position. From here, the pins 58 of the second actuating assembly are moved to their lowermost position, lowering the stack of non-target containers 20, 22, 24, 50, 52 until the bottom non-target container i.e. the fifth non-target container 52, is received within the cavity 46, positioned on top of the retractable rails 54, as shown in FIG. 7j. The pins 58 are then retracted to disengage the fifth non-target container 52 and moved in the upward stroke to their uppermost position within the guide 60, as shown in FIG. 7k. Following that, the pins 58 are moved to their extended position to engage the fourth non-target container 50 and lift the stack of non-target containers 20, 22, 24, 50 clear of the fifth non-target container 52 located in the cavity 46. The fifth non-target container 52 is then returned to the target container row 8 by the first actuating assembly, as shown in FIG. 7l. Following the return of the fifth non-target container 52, the pins 58 are moved to their lowermost position, bringing the fourth non-target container 50 into the cavity 46 to be returned to the target container row 8, as shown in FIG. 7m, and the process is repeated until all of the non-target containers 20, 22, 24, 50, 52 have been returned to the target container row as provided by the first and second actuating assemblies, as shown in FIG. 7n. Following the return of the non-target containers 20, 22, 24, 50, 52, the retractable rails 54 are moved to their retracted position, as shown in FIG. 70, and the platform 62 is raised, lifting the target container 18 into the cavity 46. From here, the retractable rails 54 are moved to their extended position, wedging themselves between the platform 62 and the underside of the target container 18 to support the weight of the container 18, as shown in FIG. 7p, and the target container 18 is then moved by the first actuating assembly out of the load handling device 16 for delivery to a workstation 6.

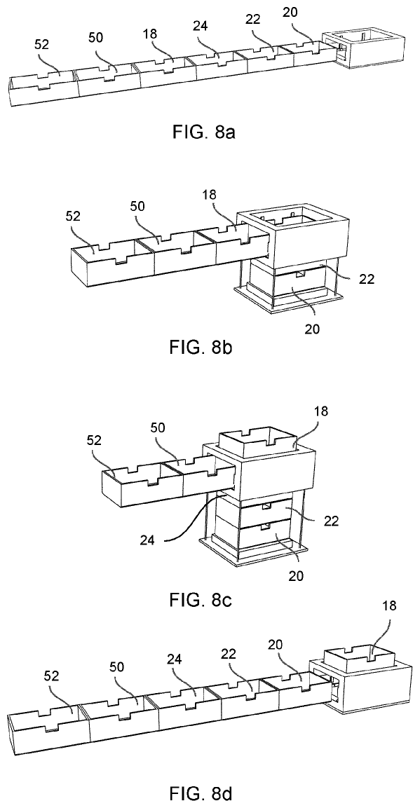

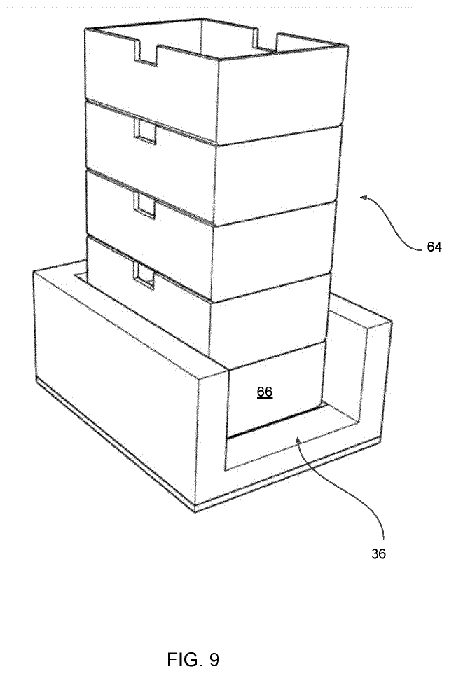

FIGS. 8a to 8d show another example of how non-target containers can be accumulated, this time using the third actuating assembly, in order to access a target container. In this example, the target container 18 is the fourth container within the target container row 8, and the first to third, and fifth and sixth containers are non-target containers 20, 22, 24, 50, 52, as shown in FIG. 8a. In this example, the first non-target container 20 is driven by the first actuating assembly into the cavity 46 of the load handling device 16, pulling the container row 8 along with it. Following that, the retractable rails 54 and the pins 58 of the second actuating assembly are retracted, lowering the first non-target container 20 onto the platform 62 of the third actuating assembly. The platform 62 is then lowered and the retractable rails 54 are extended in preparation for receipt of the second non-target container 22, which is driven into the cavity 46 of the load handling device 16 by the first actuating assembly. The retractable rails 54 are then retracted, causing the second non-target container 22 to sit on top of the first non-target container 20 in a stacked arrangement. The platform 62 then lowers the first and second non-target containers 20, 22 and the retractable rails 54 are extended in preparation for receipt of the third non-target container 24. This iterative process using the first and third actuating assemblies continues until the target container 18 is brought into the cavity 46, as shown in FIG. 8b. From here, the pins 58 are moved to their lowermost position within the guide 60, if not already there, and are extended from their retracted position to engage the target container 18. The pins 58 are then moved to their uppermost position, lifting the target container 18 out of the cavity 46, as shown in FIG. 8c. The retractable rails 54 are then retracted, allowing the platform 62 to lift the third non-target container 24 into the cavity 46, following which the retractable rails 54 are then extended, wedging themselves between the platform 62 and the third non-target container 24 to bear the weight of the third non-target container 24. The third non-target container 24 is then driven back into the target container row 8 by the first actuating assembly. The retracted rail 54 are again retracted and the process of returning the first and second non-target containers 20, 22 to the target container row 8 is continued in the same manner, as shown in FIG. 8d. From here, the pins 58 of the second actuating assembly return to their lowermost position, lowering the target container 18 into the cavity 46, from where it is then moved out of the load handling device 16 for delivery to a workstation 6 by the first actuating assembly.

The processes described above are just two examples of how the load handling device 16 is able to access a target container within a target container row by upwardly or downwardly accumulating non-target containers using the first, second and third actuating assemblies. In another example, the non-target containers may be accumulated in both directions, upwards and downwards, in order to access the target container. Moreover, instead of accumulating just non-target containers, the load handling device 16 may also accumulate target containers for bulk delivery to a workstation 6 in the same manner in which it accumulates non-target containers. To this end, the second end 36 of the load handling device 16 is an open end so the stack of target containers 64 is able to pass therethrough for delivery to a workstation 6, as shown in FIG. 9. In this example, a stack of target containers 64 may have been downwardly accumulated using the third actuating assembly and then lifted until the lowermost target container 66 is within the cavity 46. The retractable rails 54 then extend, forcing themselves between the platform 62 and the lowermost container 66, to bear the weight of the stack of target containers 64. From here, the first actuating assembly acts on the lowermost target container 66 to drive the stack of target containers 64 out of the load handling device 16 for delivery to a workstation 6. Alternatively, the stack of target containers 64 could have been upwardly accumulated using the second actuating assembly and then lowered using pins 58 until the lowermost target container 66 is held within the cavity 46. From here, as before, the first actuating assembly acts on the lowermost target container 66 to drive the stack of target containers 64 out of the load handling device 16 for bulk delivery to a workstation 6.

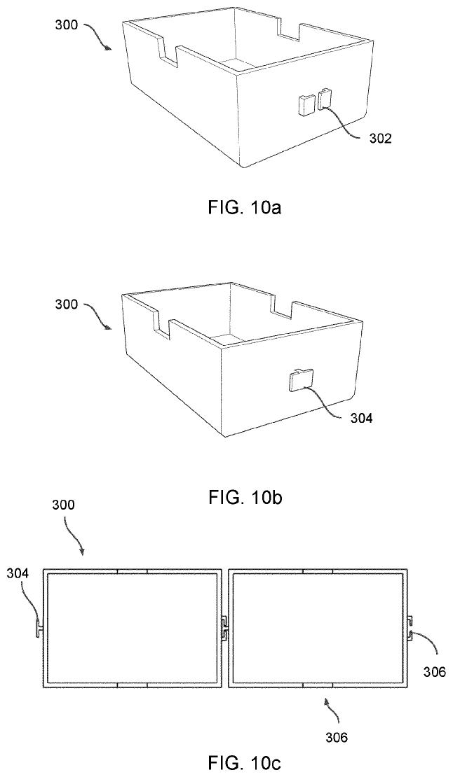

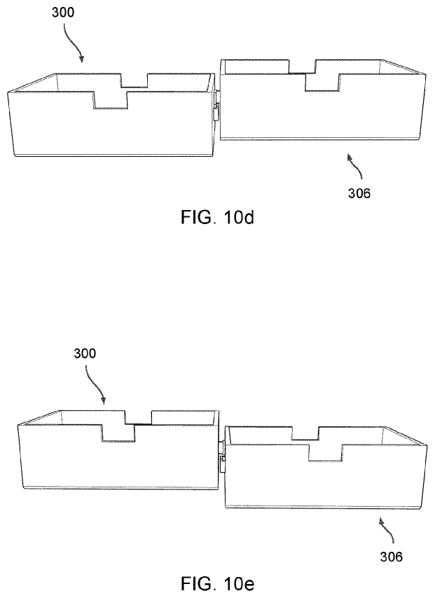

The vertical movements as provided by the second and third actuating assemblies lends itself to a passive coupling of containers within a container row 8. An example of such a coupling is shown in FIGS. 10a to 10e. In this example, each container 300 comprises complimentary female and male connectors 302, 304 that cooperate to couple adjacent containers 300, 306. The connectors 302, 306 are configured to connect or disconnect when the end container 306 is lifted or lowered by the second or third actuating assembly with respect the other containers 300 in the container row 8.

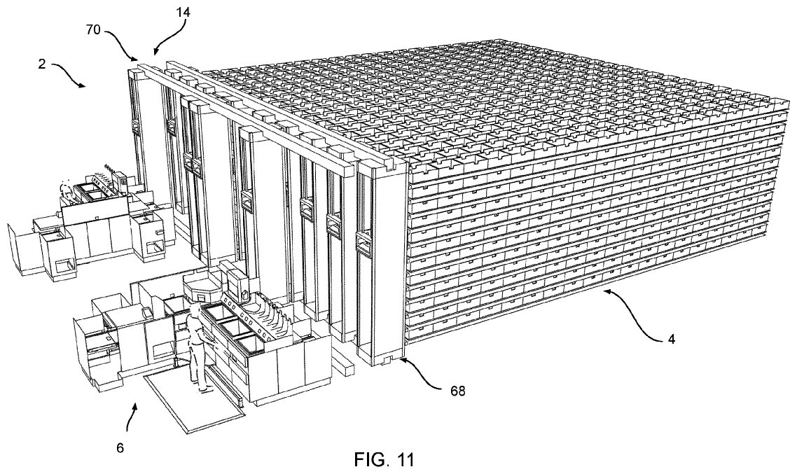

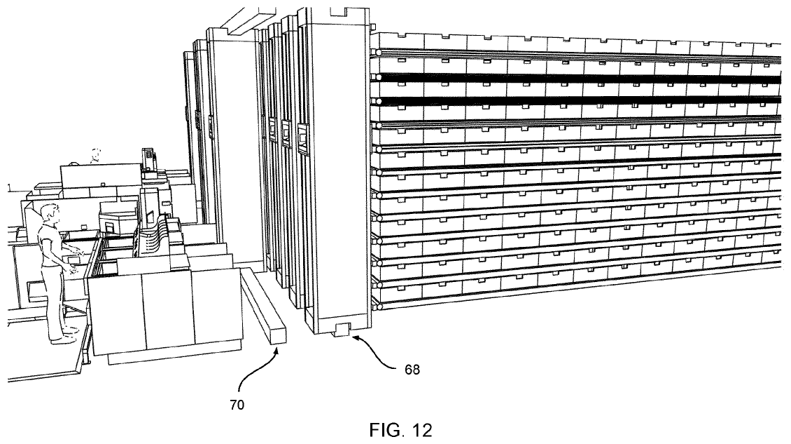

FIGS. 11 and 12 show another embodiment of a container storage and retrieval system 2 in accordance with the present invention. This embodiment is similar to the previous embodiment insofar as the functionality of the load handling devices 16 are concerned but differs in that the load handling assembly 14 comprises two adjacent rows 68, 70 of multiple load handling devices 16, along with the other components described above, such as the lifting device 17, necessary for facilitating the lateral and vertical movements thereof. The load handling devices 16 on the second row 70 are configured to retrieve a container from or deliver a container to a load handling device on the first row 68 using the first actuating assembly. Due to the presence of the other load handling devices 16 on the first row 68, a single load handling device 16 on that row is only able to retrieve containers from and add containers to container rows 8 within a limited number of columns of container rows 8. That is, the extent to which a load handling device 16 on the first row 68 can move laterally is limited by the presence of the other load handling devices 16 on that row. In order to mitigate this, the second row 70 is provided having fewer load handling devices 16 when compared with the first row 68. In this example, the first and second rows 68, 70 comprise and four load handling devices 16 respectively. This results in less interference between load handling devices 16 and increases the range across which each load handling device 16 can move. In doing so, the number of locations that a container may be placed for delivery to a workstation 6 is increased without compromising the overall throughput of the system 2.

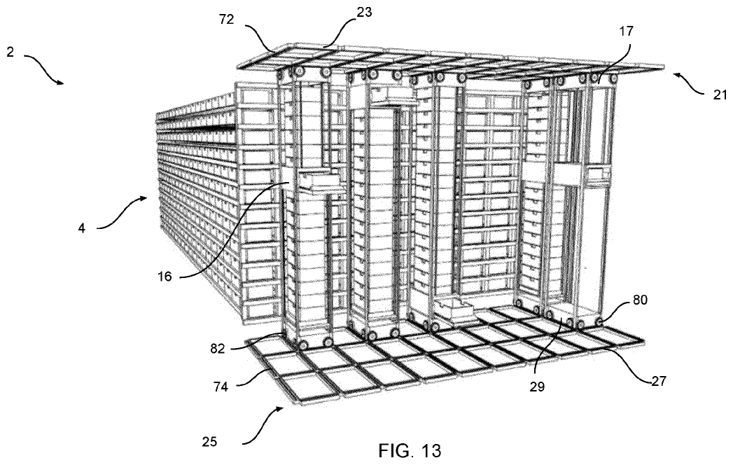

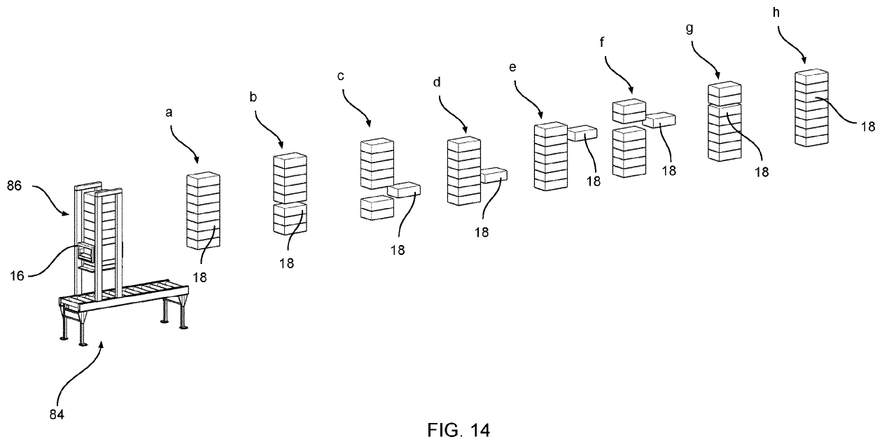

FIG. 13 shows yet another embodiment of a storage and retrieval system 2 in accordance with the present invention. In this embodiment, the load handling devices 16 are able to move towards or away from the frame structure 4 in a second substantially vertical plane extended perpendicularly with respect to the first substantially vertical plane, as well as being able to move laterally. To this end, the first and second guide ways 21, 25 comprise multiple cross members 23, 27 and longitudinal members 72, 74 that combine to form grids 76, 78 in front of the frame structure 4, one grid 76 for engagement with the lift devices 17 and the other grid 78 for engagement with the base units 29. The lifting devices 17 and base units 29 each comprise at least two sets of wheels 80, 82, one set of wheels 80 being arranged to engage the cross members 23, 27 of the grids 76, 78 to drive the load handling device 16 laterally, across the side 15 of the frame structure 4, the other set of wheels 82 being arranged to engage the longitudinal members 72, 74 of the grids 76, 78 to drive the load handling devices 16 towards or away from the frame structure 4. This arrangement improves the manoeuvrability of the load handling devices 16 such that they are able to access all of the container rows 8.

FIG. 14 shows an example of another application for the load handling device 16. In this example, the load handling device 16 is stationary on a conveyor 84 and accepts a stack of containers 86, shuffles them using the first, second and third actuating assemblies into a predetermined order and outputs the stack 86 to the same or another conveyor. In this example, which only uses the first and second actuating assemblies, a target container 18 is positioned third from the bottom within the stack of containers 86, as shown in step a, and needs to be moved to a position third from the top of the stack 86, as shown in final step h. From step a, the second actuating assembly of the load handling device 16 lifts the top five containers in order to access the target container 18, as shown in step b. The target container 18 is then removed from the stack 86 by the first actuating assembly at step c, and the top five containers are placed onto the stack 86 at step d. At step e, the target container 18 is then moved into position for insertion back into the stack 86 and the top two containers are lifted from the stack 86 at step f. The target container 18 is then reinserted into the stack 86 at step g and the top two containers are lowered onto the target container 18 at step h, completing the stack 86.

1.-31. (canceled)

32. A load handling device for a container storage and retrieval system, the container storage and retrieval system including a frame structure configured to store a plurality of rows of containers, the load handling device being configured to be positionable between the frame structure and a workstation and comprising:
a first actuating assembly configured to move a container row lengthwise in order to retrieve a container from the container row for delivery to a workstation or add a container from a workstation to the container row.

33. A load handling device according to claim 32, wherein the first actuating assembly is configured to move laterally in a first direction in order to engage a container within a container row adjacent to a first end of the load handling device, and in a second opposite direction in order to engage a container from the workstation adjacent to a second opposite end of the load handling device.

34. A load handling device according to claim 33, wherein the first actuating assembly comprises:
first and second actuating members, wherein the first actuating member is configured to move laterally in the first and second directions so as to move away from and towards the second actuating member respectively.

35. A load handling device according to claim 34, wherein the second actuating member is configured to move laterally in the first and second directions so as to move towards and away from the first actuating member respectively.

36. A load handling device according to claim 32, wherein the first actuating assembly comprises:
a gear arrangement.

37. A load handling device according to claim 36, wherein the gear arrangement comprises:
a worm gear configured to mesh with a corresponding track extending along a side of the container.

38. A load handling device according to claim 32, comprising:
a second actuating assembly configured to stack upwards one or more containers following their retrieval from a container row such that another container from the container row can be accessed.

39. A load handling device according to claim 38, wherein the second actuating assembly comprises:
a pin for engaging a container, the pin being configured to move in an upward stroke to lift a container into a stackable position.

40. A load handling device according to claim 39, wherein the pin is configured to move in a downward stroke to lower a container from the stackable position.

41. A load handling device according to claim 39, wherein the pin is retractable for disengaging a container.

42. A load handling device according to claim 41, wherein the pin is configured to move in the upward and downward strokes when retracted.

43. A load handling device according to claim 31, comprising:
a third actuating assembly configured to stack downwards one or more containers following their retrieval from a container row such that another container from the container row can be accessed.

44. A load handling device according to claim 43, wherein the third actuating assembly comprises:
a platform for holding one or more containers retrieved from a container row in a stacked arrangement, the third actuating assembly being configured to lower the platform such that another container from the container row can be accessed.

45. A load handling device according to claim 32, in combination with a container storage and retrieval system, wherein each container row of the storage and retrieval system comprises:
a plurality of containers configured to releasably interlock or engage with one another in a longitudinal direction, and wherein the load handling device comprises:
means for decoupling a container from or coupling a container to a container row as the first actuating assembly moves the container row lengthwise.

46. A load handling device according to claim 32, in combination with a load handling assembly of a container storage and retrieval system.

47. The combination according to claim 46, comprising:
a lifting device engaged with the load handling device, the lifting device being configured to move the load handling device vertically such that the load handling device can access different rows of containers arranged in a vertical column.

48. The combination according to claim 47, wherein the lifting device comprises:
cables connected to the load handling device and one or more spool devices configured to extend and retract the cables in order to move the load handling device vertically.

49. The combination according to claim 46, wherein the load handling device is configured to move laterally so as to access rows of containers arranged in different vertical columns.

50. The combination according to claim 46, wherein the load handling device is configured to move longitudinally away from or towards the framework structure.

51. The combination according to claim 49, comprising:
a first guide way including a cross member for guiding lateral movement of the load handling device and/or a longitudinal member for guiding longitudinal movement of the load handling device.

52. The combination according to claim 51, wherein the lifting device is configured to engage the cross member so as to guide the lateral movement of the load handling device and/or the longitudinal member so as to guide the longitudinal movement of the load handling device.

53. The combination according to claim 51, comprising:
a second guide way including a cross member for guiding the lateral movement of the load handling device and/or a longitudinal member for guiding the longitudinal movement of the load handling device.

54. The combination according to claim 53, comprising:
a base unit for supporting the lifting device, the base unit being configured to engage the cross member of the second guide way so as to guide the lateral movement of the load handling device and/or the longitudinal member of the second guide way so as to guide the longitudinal movement of the load handling device.

55. The combination according to claim 46, comprising:
a support frame defining a channel for guiding vertical movement of the load handling device.

56. The combination according to claim 46, comprising:
a first row including a plurality of lifting devices and respective load handling devices, each lifting device being positioned such that its respective load handling device can access different rows of containers arranged in a vertical column.

57. The combination according to claim 56, comprising:
a second row extending alongside the first row, the second row including at least one lifting device and a load handling device, the load handling assembly being configured such that the load handling device on the second row is able to move laterally so as to retrieve a container from or deliver a container to a load handling device on the first row.

58. A container storage and retrieval system having a load handling assembly according to claim 46, the system comprising:
a frame structure configured to store a plurality of rows of containers and a workstation; and
the load handling assembly.

59. A method of retrieving one or more target containers from a container storage and retrieval system, the method comprising:
moving a load handling device to a target container row of the container storage and retrieval system;
moving the target container row lengthwise using the load handling device to retrieve an end container from the target container row;
determining if the retrieved container is the target container; and
moving the retrieved container using the load handling device to a temporary storage location when the retrieved container is determined to be a non-target container; or
moving the retrieved container out of the load handling device for delivery to a workstation when the retrieved container is determined to be the target container.

60. A method according to claim 59, comprising:
stacking upwards one or more non-target containers using the load handling device to allow access to the target container row.

61. A method according to claim 60, comprising:
stacking downwards one or more non-target containers using the load handling device to allow access to the target container row.

62. A method according to claim 59, comprising:
pushing the target container row or another row of containers using the load handling device to return one or more non-target containers.
